(19) United States
(12) Patent Application Publication
(10) Pub. No.: US 2011/0199337 A1
(43) Pub. Date: Aug. 18, 2011

(54) OBJECT-DETECTING SYSTEM AND METHOD BY USE OF NON-COINCIDENT FIELDS OF LIGHT

(75) Inventors: Chien-Hsing Tang, Taoyuan (TW); Hua-Chun Tsai, Taoyuan (TW); Yu-Wei Liao, Taoyuan (TW)

(73) Assignee: QISDA CORPORATION, Taoyuan (TW)

(21) Appl. No.: 13/024,338

(22) Filed: Feb. 10, 2011

(30) Foreign Application Priority Data
Feb. 12, 2010 (TW) 099104529

(51) Int. Cl. G06F 3/042

(52) U.S. Cl. 345/175

(57) ABSTRACT

The invention provides an object-detecting system and method for detecting information of an object located in an indicating space. In particular, the invention is to capture images relative to the indicating space by use of non-coincident fields of light, and further to determine the information of the object located in the indicating space in accordance with the captured images.

### CROSS-REFERENCE TO RELATED APPLICATION

This utility application claims priority to Taiwan Application Serial Number 099104529, filed Feb. 12, 2010, which is incorporated herein by reference.

### BACKGROUND OF THE INVENTION

1. Field of the Invention

This present invention relates to an object-detecting system and method, and more particularly, to an object-detecting system and method by use of non-coincident fields of light and single-line image sensor and single line image sensor.

2. Description of the Prior Art

Since touch screens have the advantage of enabling operators to intuitively input coordinate relative to the display device via touch method, touch screens have become popular input devices equipped by modern display apparatuses. Touch screens have been widely applied to various electronic products having display apparatuses, such as monitors, laptop computers, tablet computers, automated teller machines (ATM), point of sale, tourist guiding systems, industrial control systems, mobile phones, and so on.

Besides conventional resistive-type and conductive-type touch screens with which operators have to input in direct contact, optical touch screens utilizing image capturing units with which operators need not to actually contact the screen has also been widely adopted. The prior art related to non-contact touch screen (or called optical touch screen) by use of image-capturing unit has been disclosed in U.S. Pat. No. 4,507,557, and discussion of unnecessary details will be hereby omitted. Aforesaid object-detecting system for detecting position of an object in optical image way cannot be applied only to touch screens, but also to touch graphics tablets, touch controllers, etc.

In order to resolve the position of input point more precisely and event to support multi-touch, certain of design solutions about different types of light source, light-reflecting device and light-guiding device have been proposed to provide more angular functions related to the positions of input points to benefit in precise resolution of the positions. For example, U.S. Pat. No. 7,460,110 discloses that an object having a radiation light source is located in an indicating area and cooperates with a waveguide and minors extend along both sides of the waveguide to form an upper layer and a lower layer of coincident fields of light. Thereby, an image-capturing unit can capture images of the upper layer and the lower layer simultaneously.

However, it is necessary to use expansive image sensor like an area image sensor, a multiple-line image sensor or a double-line image sensor to capture the images of the upper layer and the lower layer simultaneously. Moreover, the optical touch screen needs more computation resource to resolve the image captured by the area image sensor, the multiple-line image sensor and the double-line image sensor, especially the area image sensor. Additionally, these image sensors, especially the double-line image sensor, may sense wrong fields of light or fail to sense the field of light due to the assembly error of the optical touch screen.

Besides, the optical touch screen according to U.S. Pat. No. 7,460,110 needs an object having a radiation light source, a waveguide and mirrors; three cooperate at the same time to achieve an upper layer and a lower layer of coincident fields of light simultaneously. Obviously, the architecture of U.S. Pat. No. 7,460,110 is very complicated. Moreover, as to the prior arts of optical touch screens, identification range of image-capturing units for indicating area and resolution of objects located in the indicating area still need to be improved.

Accordingly, an aspect of the invention is to provide an object-detecting system and method for detecting a target position of an object on an indicating plane similarly by using optical approach. Particularly, the object-detecting system and method of the invention apply non-coincident fields of light and single line image sensor to solve the problems of coincident fields of light and expensive image-capturing units resulted by the prior art.

Additionally, another aspect of the invention is to provide an object-detecting system and method for detecting object information, such as an object shape, an object area, an object stereo-shape, an object volume, and son on of an object in the indicating space.

### SUMMARY OF THE INVENTION

An object-detecting system, according to a preferred embodiment of the invention, includes a peripheral member, a light-filtering device, a reflector, a first retro-reflector, a second retro-reflector, a third retro-reflector, a controlling unit, a first light-emitting unit, and a first image-capturing unit. The peripheral member defines an indicating space and an indicating plane in the indicating space on which an object directs a target position. The indicating plane defines a first side, a second side adjacent to the first side, a third side adjacent to the second side, and a fourth side adjacent to the third side and the first side. The third side and the fourth side form a first corner, and the second side and the third side form a second corner. The light-filtering device is disposed on the peripheral member and located at the first side. The reflector is disposed on the peripheral member and located at the first side and a back of the light-filtering device. The first retro-reflector is disposed on the peripheral member and located at the first side and above or underneath the reflector. The second retro-reflector is disposed on the peripheral member and located at the second side. The third retro-reflector is disposed on the peripheral member and located at the third side. The first light-emitting unit is electrically connected to the controlling unit and disposed at the periphery of the first corner. The first light-emitting unit includes a first light source and a second light source. The first light-emitting unit is controlled by the controlling unit to drive the first light source emitting a first light. The first light passes through the indicating space to form a first field of light. The first light-emitting unit is also controlled by the controlling unit to drive the second source emitting a second light. The second light passes through the indicating space to form a second field of light. The light-filtering device disables the first light to pass, but enables the second light to pass. The first image-capturing unit is electrically connected to the controlling unit and disposed at the periphery of the first corner. The first image-capturing unit defines a first image-capturing point. The first image-capturing unit is controlled by the controlling unit to capture a first image of portion of the peripheral member on the first side and the second side shown by the first retro-reflector and the second retro-reflector when the first field of light is formed. The first image-capturing unit is also controlled by the controlling unit to capture a first reflected image of portion of the peripheral member on the third side and the second side shown by the third retro-reflector and the reflector. The controlling unit processes the first image and the first reflected image to determine an object information of the object located in the indicating space.

In one embodiment, the reflector is a plane minor.

In another embodiment, the reflector includes a first reflective plane and a second reflective plane. The first reflective plane and the second reflective plane substantially intersect at a right angle of intersection, and face the indicating space. The indicating plane defines a primary extension plane. The first reflective plane defines a first secondary extension plane. The second reflective plane defines a second secondary extension plane. The first secondary extension plane and the second secondary extension plane respectively intersect with the primary extension plane at an angle of about 45 degrees.

In one embodiment, the reflector is a prism.

In one embodiment, the first image-capturing unit is a line image sensor.

The object-detecting system, according to another preferred embodiment of the invention, further includes a fourth retro-reflector, a second light-emitting unit and a second image-capturing unit. The fourth retro-reflector is disposed on the peripheral member and located at the fourth side. The second light-emitting unit is electrically connected to the controlling unit and disposed at the periphery of the second corner. The second light-emitting unit includes a third light source and a fourth light source. The second light-emitting unit is controlled by the controlling unit to drive the third light source emitting the first light. The second light-emitting unit is also controlled by the controlling unit to drive the fourth light source emitting the second light. The second image-capturing unit is electrically connected to the controlling unit and disposed at the periphery of the second corner. The second image-capturing unit defines a second image-capturing point. The second image-capturing unit is controlled by the controlling unit to capture a second image of portion of the peripheral member on the first side and the fourth side shown by the first retro-reflector and the fourth retro-reflector when the first field of light is formed. The second image-capturing unit is also controlled by the controlling unit to capture a second reflected image of portion of the peripheral member on the third side and the fourth side shown by the third retro-reflector and the reflector when the second field of light is formed. The controlling unit processes at least two among the first image, the second image, the first reflected image, and the second reflected image to determine the object information.

In one embodiment, the second image-capturing unit is a line image sensor.

An object-detecting method, according to a preferred embodiment of the invention, is implemented on the basis of a peripheral element, a light-filtering device, a reflector, a first retro-reflector, a second retro-reflector, and a third retro-reflector. The peripheral member defines an indicating space and an indicating plane in the indicating space on which an object directs a target position. The indicating plane defines a first side, a second side adjacent to the first side, a third side adjacent to the second side, and a fourth side adjacent to the third side and the first side. The third side and the fourth side form a first corner. The second side and the third side form a second corner. The light-filtering device is disposed on the peripheral member and located at the first side. The reflector is disposed on the peripheral member and located at the first side and a back of the light-filtering device. The first retro-reflector is disposed on the peripheral member and located at the first side and above or underneath the reflector. The second retro-reflector is disposed on the peripheral member and located at the second side. The third retro-reflector is disposed on the peripheral member and located at the third side. The object-detecting method according to the invention, firstly, at the first corner, is to emit a first light forward the indicating space, where the first light passes through the indicating space to form a first field of light. Then, the object-detecting method according to the invention, at the first corner, is to capture a first image of portion of the peripheral member on the first side and the second side shown by the first retro-reflector and the second retro-reflector when the first field of light is formed. Next, the object-detecting method according to the invention, at the first corner, is to emit a second light forward the indicating space, where the light-filtering device disables the first light to pass, but enables the second light to pass. The second light passes through the indicating space to form a second field of light. Afterward, the object-detecting method according to the invention, at the first corner, is to capture a first reflected image of portion of the peripheral member on the third side and the second side shown by the third retro-reflector and the reflector when the second field of light is formed. Finally, the object-detecting method according to the invention is to process the first image and the first reflected image to determine an object information of the object located in the indicating space.

The advantage and spirit of the invention may be understood by the following recitations together with the appended drawings.

### BRIEF DESCRIPTION OF THE APPENDED DRAWINGS

FIG. 1A illustratively shows the architecture of the object-detecting system according to a preferred embodiment of the invention.

FIG. 1B is a cross sectional view along line A-A of the peripheral member, the light-filtering device, the reflector, and the first retro-reflector shown in FIG. 1A.

FIG. 2A schematically illustrates that two input points P1 and P2 obstruct the pathways of the light to the first image-capturing unit and the second image-capturing unit when the first field of light and the second field of light are formed respectively.

FIG. 2B schematically illustrates that the first image-capturing unit respectively captures an image related to the first field of light at time T0 and another image related to the second field of light at time T1.

FIG. 2C schematically illustrates that the second image-capturing unit respectively captures an image related to the first field of light at time T0 and another image related to the second field of light at time T1.

FIG. 3 shows a flow chart illustrating an object-detecting method according to a preferred embodiment of the invention.

### DETAILED DESCRIPTION OF THE INVENTION

The invention provides an object-detecting system and method for detecting a target position of an object on an indicating plane similarly in optical approach. Additionally, the object-detecting system and method according to the invention can detect object information, such as an object shape, an object area, an object stereo-shape, an object volume, and so on of an object in the indicating space including the indicating plane. Moreover, particularly, the object-detecting system and method according to the invention apply non-coincident fields of light. Thereby, the object-detecting system and method according to the invention can utilize cheaper image sensor and consume less computation resource. With the following detailed explanations of the preferred embodiments, the features, spirits, advantages, and feasibility of the invention will be hopefully well described.

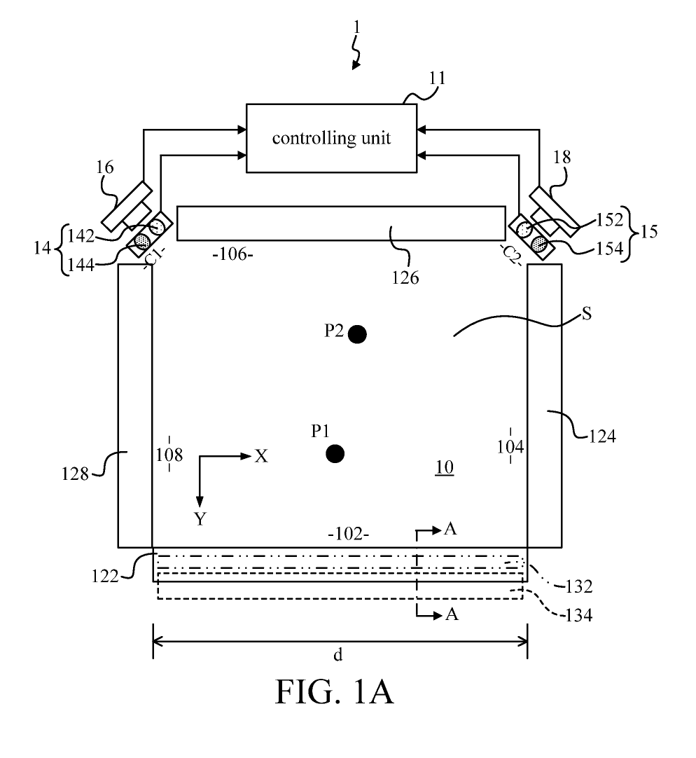

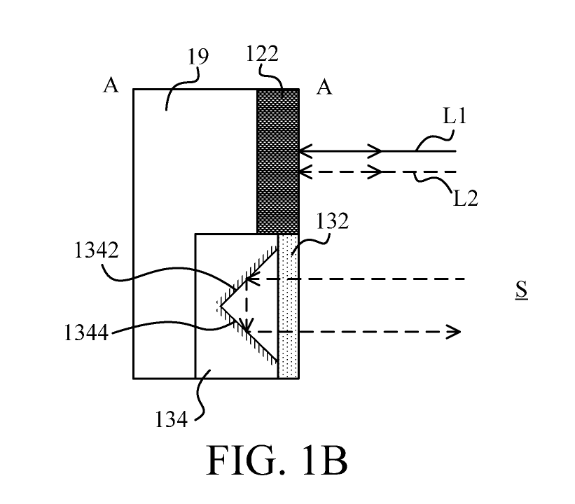

Referring to FIG. 1A and FIG. 1B, FIG. 1A illustratively shows the architecture of the object-detecting system 1 according to a preferred embodiment of the invention. FIG. 1B is a cross sectional view along line A-A of the partial peripheral member 19 (not shown in FIG. 1A), a light-filtering device 132, a reflector 134, and a first retro-reflector 122 shown in FIG. 1A. The object-detecting system 1 according to the invention is used for detecting position of at least one object (such as fingers, stylus, etc.) on an indicating plane 10, e.g., the positions of tow point (P1 and P2) as shown in FIG. 1A.

As shown in FIG. 1A, the object-detecting system 1 according to the invention includes the polygonal peripheral member 19 (not shown FIG. 1A, referring to FIG. 1B), the light-filtering device 132, the reflector 134, the first retro-reflector 122, a second retro-reflector 124, a third retro-reflector 126, a controlling unit 11, a first light-emitting unit 14, and a first image-capturing unit 16. The peripheral member 19 defines an indicating space S and an indicating plane 10 in the indicating space S. That is, the peripheral member 19 surrounds the indicating space S and the indicating plane 10. The peripheral member 19 is approximately as high as the indicating space S, and provided the objects to direct target position (P1, P2) on the indicating plane 10. The indicating plane 10 defines a first side 102, a second side 104 adjacent to the first side 102, a third side 106 adjacent to the second side 104, and a fourth side 108 adjacent to the third side 106 and the first side 102. The third side 106 and the fourth side 108 form a first corner C1. The second side 104 and the third side 106 form a second corner C2.

Also as sown in FIG. 1A, the light-filtering device 132 is disposed on the peripheral member 19 and located at the first side 102. As shown in FIG. 1B, the reflector 134 is disposed on the peripheral member 19 and located at the first side 102 and a back of the light-filtering device 132. The first retro-reflector 122 is disposed on the peripheral member 19 and located at the first side 102 and above or underneath the reflector 134. In this case shown in FIG. 1B, the first retro-reflector 122 above the reflector 134 is taken as an example for explanation. The second retro-reflector 124 is disposed on the peripheral member 19 and located at the second side 104. The third retro-reflector 126 is disposed on the peripheral member 19 and located at the third side 106. Each of the retro-reflectors (122, 124, 126) reflects back an incident light L1 with a propagation path into a reflected light L2 along a propagation path opposite and parallel to the propagation path of the incident light L1, as shown in FIG. 1B.

Also shown in FIG. 1A, the first light-emitting unit 14 is electrically connected to the controlling unit 11, and disposed at the periphery of the first corner C1. The first light-emitting unit 14 includes a first light source 142 and a second light source 144. The first light-emitting unit 14 is controlled by the controlling unit 11 to drive the first light source 142 emitting a first light. The first light passes through the indicating space S to form a first field of light. The first light-emitting unit 14 is also controlled by the controlling unit 11 to drive the second source 144 emitting a second light. The second light passes through the indicating space S to form a second field of light. In particular, as shown in FIG. 1B, the light-filtering device 132 disables the first light to pass, but enables the second light to pass. In FIG. 1B, the solid line with arrow represents the propagation path of the first light, and the dashed line with arrow represents the propagation path of the second light. Also as shown in FIG. 1B, the first light and the second light both are retro-reflected by the first retro-reflector 122. The second light passes through the light-filtering device 132, and further is normally reflected by the reflector 134. The first light cannot pass through the light-filtering device 132, and not be reflected by the light-filtering device 132.

In practical application, the first light source 142 can be an infrared emitter emitting radiation of 850 nm wave length, and the second light source 144 can be an infrared emitter emitting radiation of 940 nm wave length.

In one embodiment, the reflector 134 is a plane mirror.

In another embodiment, as shown in FIG. 1B, the reflector 134 can include a first reflective plane 1342 and a second reflective plane 1344. The first reflective plane 1342 and the second reflective plane 1344 substantially intersect at a right angle of intersection, and face the indicating space S. The indicating plane 10 defines a primary extension plane. The first reflective plane 1342 defines a first secondary extension plane. The second reflective plane 1344 defines a second secondary extension plane. The first secondary extension plane and the second secondary extension plane respectively intersect with the primary extension plane at an angle of about 45 degrees. In practical application, the aforesaid reflector 134 can be a prism.

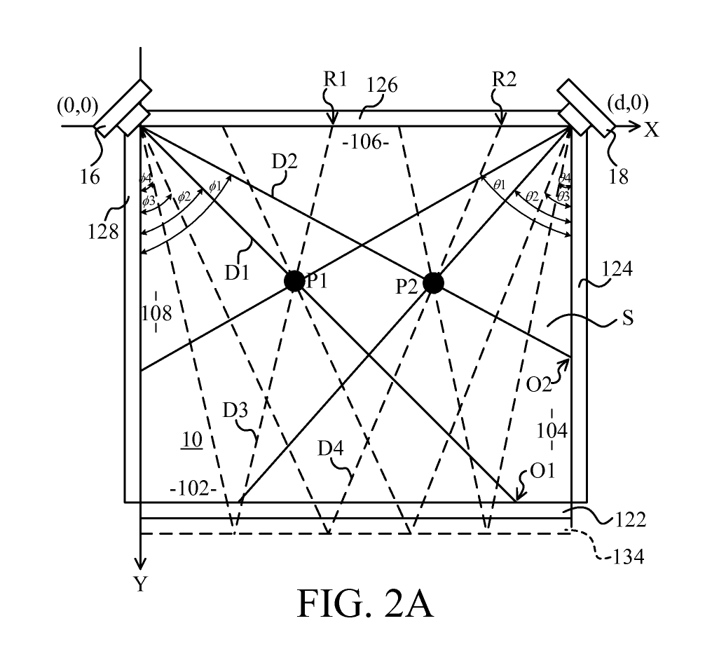

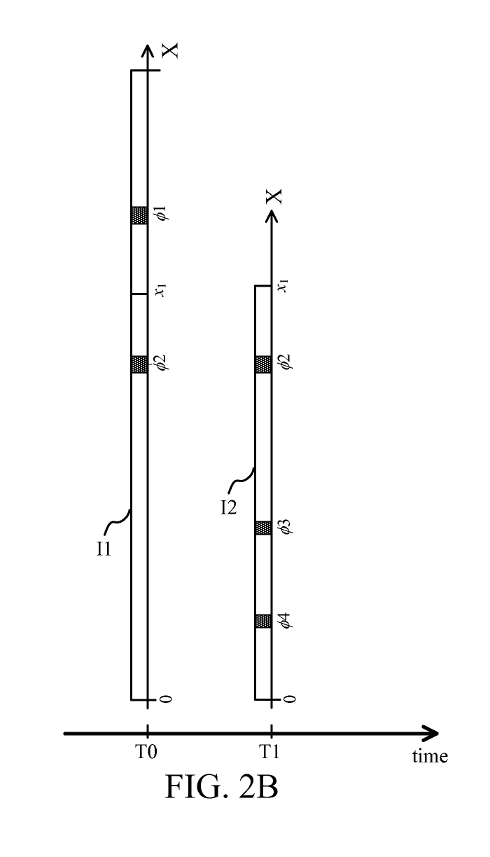

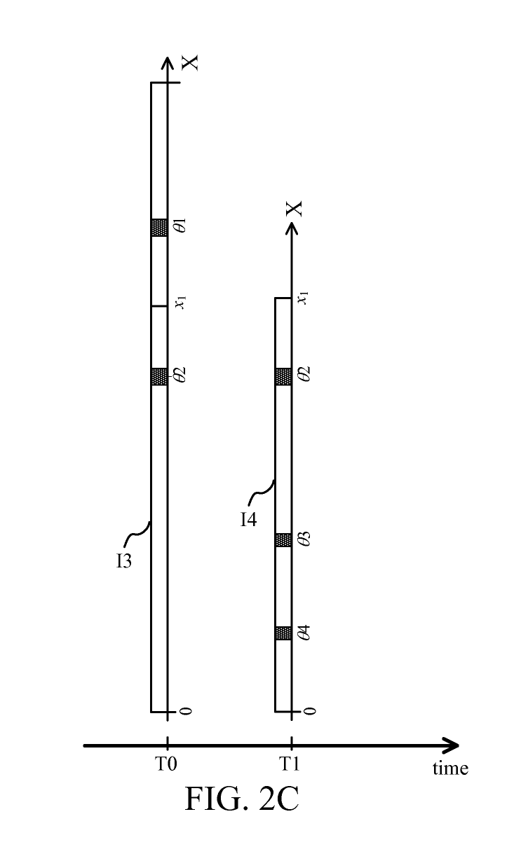

The first image-capturing unit 16 is electrically connected to the controlling unit 11 and disposed at the periphery of the first corner C1. The first image-capturing unit 16 defines a first image-capturing point. The first image-capturing unit 16 is controlled by the controlling unit 11 to capture a first image of portion of the peripheral member 19 on the first side 102 and the second side 104 shown by the first retro-reflector 122 and the second retro-reflector 124 when the first field of light is formed. The first image includes the obstruction of the object in the indicating space S to the first light, that is, the shadow projected on the first image, e.g., the shadow on the image I1 shown in FIG. 2B. The case shown in FIG. 2B will be described in detail in the following. The first image-capturing unit 16 is also controlled by the controlling unit 11 to capture a first reflected image of portion of the peripheral member 19 on the third side 106 and the second side 104 shown by the third retro-reflector 126 and the reflector 134 when the second field of light is formed. The first reflected image includes the obstruction of the object in the indicating space S to the second light, that is, the shadow projected on the first reflected image, e.g., the shadow on the image 12 shown in FIG. 2B. The case shown in FIG. 2B will be described in detail in the following.

In one embodiment, the first image-capturing unit 16 can be a line image sensor.

Finally, the controlling unit 11 processes the first image and the first reflected image to determine an object information of the object located in the indicating space S.

In one embodiment, the object information includes a relative position of the target position relating to the indicating plane 10. The controlling unit 11 determines a first object point according to the object on the first side 102 or the second side 104 in the first image, e.g., the point O1 and the point O2 shown in FIG. 2A. The controlling unit 11 also determines a first reflective object point according to the object in the first reflected image on the third side 106, e.g., the point R1 and the point R2 shown in FIG. 2A. The controlling unit 11 also determines a first propagation path (e.g., the path D1 and the path D2 shown in FIG. 2A) according to the connective relationship between the first image-capturing point (e.g., the coordinate (0,0) shown in FIG. 2A) and the first object point (e.g., the point O1 and the point O2 shown in FIG. 2A), and determines a first reflective path (e.g., the path D3 and the path D4 shown in FIG. 2A) according to the connective relationship between the first image-capturing point (e.g., the coordinate (0,0) shown in FIG. 2A) and the first reflective object point (e.g., the point R1 and the point R2 shown in FIG. 2A) and the reflector 134. Furthermore, the controlling unit 11 determines the relative position according to the intersection of the first propagation path and the first reflective path.

Also shown in FIG. 1A, the object-detecting system 1, according to another preferred embodiment of the invention, further includes a fourth retro-reflector 128, a second light-emitting unit 15 and a second image-capturing unit 18.

The fourth retro-reflector 128 is disposed on the peripheral member 19, and located at the fourth side 108. The second light-emitting unit 15 is electrically connected to the controlling unit 11, and disposed at the periphery of the second corner C2. The second light-emitting unit 15 includes a third light source 152 and a fourth light source 154. The second light-emitting unit 15 is controlled by the controlling unit 11 to drive the third light source 152 emitting the first light. In practical application, the first light source 142 and the third light source 152 are simultaneously driven emitting the first light, and the first light passes through the indicating space S to form the first field of light.

The second light-emitting unit 15 is also controlled by the controlling unit 11 to drive the fourth light source 154 emitting the second light. In practical application, the second light source 144 and the fourth light source 154 are simultaneously driven emitting the second light, the second light passes through the indicating space S to form the second field of light.

The second image-capturing unit 18 is electrically connected to the controlling unit 11, and disposed at the periphery of the second corner C2. The second image-capturing unit 18 defines a second image-capturing point. The second image-capturing unit 18 is controlled by the controlling unit 11 to capture a second image of portion of the peripheral member 19 on the first side 102 and the fourth side 108 shown by the first retro-reflector 122 and the fourth retro-reflector 128 when the first field of light is formed. The second image includes the obstruction of the object in the indicating space S to the first light, that is, the shadow projected on the second image, e.g., the shadow on the image 13 shown in FIG. 2C. The case shown in FIG. 2C will be described in detail in the following. The second image-capturing unit 18 is also controlled by the controlling unit 11 to capture a second reflected image of portion of the peripheral member 19 on the third side 106 and the fourth side 108 shown by the third retro-reflector 126 and the reflector 134 when the second field of light is formed. The second reflected image includes the obstruction of the object in the indicating space S to the second light, that is, the shadow projected on the second reflected image, e.g., the shadow on the image 14 shown in FIG. 2C. The case shown in FIG. 2C will be described in detail in the following. In the preferred embodiment, the controlling unit 11 processes at least two among the first image, the second image, the first reflected image, and the second reflected image to determine the object information.

It should be emphasized that the controlling unit 11 can also control to drive the second light source 144 and the fourth light source 154 first emitting the second light to form the second field of light, and then control to drive the first light source 142 and the third light source 152 emitting the first light to form the first field of light.

In practical application, the second image-capturing unit 18 is a line image sensor.

The forming of the non-coincident fields of light and capturing of the images of the object-detecting system 1 according to the invention are described with an example of two input points (P1, P2) in the indicating plane 10 in FIG. 1A, the first image-capturing unit 16 and the second image-capturing unit 18.

As shown in FIG. 2A, the solid line refers to that at time T0, the controlling unit 11 controls to drive the first light source 142 and the third light source 152 emitting the first light to form the first field of light, and the input points P1 and P2 obstruct the pathways of the first light retro-reflected to the first image-capturing unit 16 and the second image-capturing unit 18. Moreover, the dashed line in FIG. 2A refers to that at time T1, the controlling unit 11 controls to drive the second light source 144 and the fourth light source 154 first emitting the second light to form the second field of light and the input points P1 and P2 obstruct the pathways of the second light retro-reflected and normally reflected to the first image-capturing unit 16 and the second image-capturing unit 18.

Also as shown in FIG. 2A, the pathways of the input points P1 and P2 obstructing the first light and the second light reflected to the first image-capturing unit 16 at time T0 and T1 respectively form four angular vectors φ2, φ1, φ4 and φ3. As shown in FIG. 2B, at time T0, the first image-capturing unit 16 captures the image I1 relating to the first field of light and thereon having the shadows of real images corresponding to the angular vectors φ2 and φ1. At time T1, the first image-capturing unit 16 captures the image 12 relating to the second field of light and thereon having the shadows of mirror images corresponding to the angular vector φ4 and φ3. Similarly, the input points P1 and P2 in the second field of light will result in that the image 12 thereon has the shadows of real images corresponding to the angular vectors φ2 and φ1. In order to reduce computation resource and shorten process time, at time T1, the first image-capturing unit 16 only captures the sub-image corresponding to the first side 102, but does not capture the sub-image corresponding to the second side 104. Therefore, the image 12 shown in FIG. 2B thereon has the shadow of real image corresponding to the angular vector φ2 besides the shadows of mirror images corresponding to the angular vectors φ4 and φ3, but has no the shadow of real image corresponding to the angular vector φ1.

Also as shown in FIG. 2A, the pathways of the input points P1 and P2 obstructing the first light and the second light reflected to the second image-capturing unit 18 at time T0 and T1 respectively form four angular vectors θ2, θ1, θ4 and θ3. As shown in FIG. 2C, at time T0, the second image-capturing unit 18 captures the image 13 relating to the first field of light and thereon having the shadows of the real images corresponding to the angular vectors θ2 and θ1. At time T1, the second image-capturing unit 18 captures the image 14 relating to the second field of light and thereon having the shadows of the minor images corresponding to the angular vectors θ4 and θ3. Similarly, the input points P1 and P2 in the second field of light will result in that the image 14 thereon has the shadows of real images corresponding to the angular vectors θ2 and θ1. In order to reduce computation resource and shorten process time, at time T1, the second image-capturing unit 18 only captures the sub-image corresponding to the first side 102, but does not capture the sub-image corresponding to the second side 104. Therefore, the image 14 shown in FIG. 2C thereon has the shadow of real image corresponding to the angular vector θ2 besides the shadows of mirror images corresponding to the angular vectors θ4 and θ3, but has no the shadow of real image corresponding to the angular vector θ1.

Obviously, the object-detecting system 1 according to the invention can preciously calculate the locations of the input points P1 and P2 in FIG. 2A by analyzing the angular vectors indicated by the shadows of images I1, I2, I3 and I4. It should be emphasized that both of the first image-capturing unit 16 and the second image-capturing unit 18 of the invention can be single-line image sensors. Thereby, it is unnecessary for the object-detecting system according to the invention to use expansive image sensors, and the assembly of the object-detecting system according to the invention can prevent from condition of image sensors sensing wrong or no filed of light. These significant differences between the invention and the prior art are the following: 1. in mirror image way to enhance identification range of the image-capturing units for the indication space; 2. addition of optical traveling distance between the image-capturing units and the corners of the indicating space to avoid low resolution such that position of the object cannot be identified when the objects are close to the corners; 3. real images and mirror images of the object being imaged on the same layer of the image-capturing units; by use of two sets of light sources with different wave lengths; 5. the objects without the need of lighting themselves; and 6. simplified architecture of the invention with comparison to the prior art with the need of a radiation light source, a waveguide and mirrors that three cooperate at the same time.

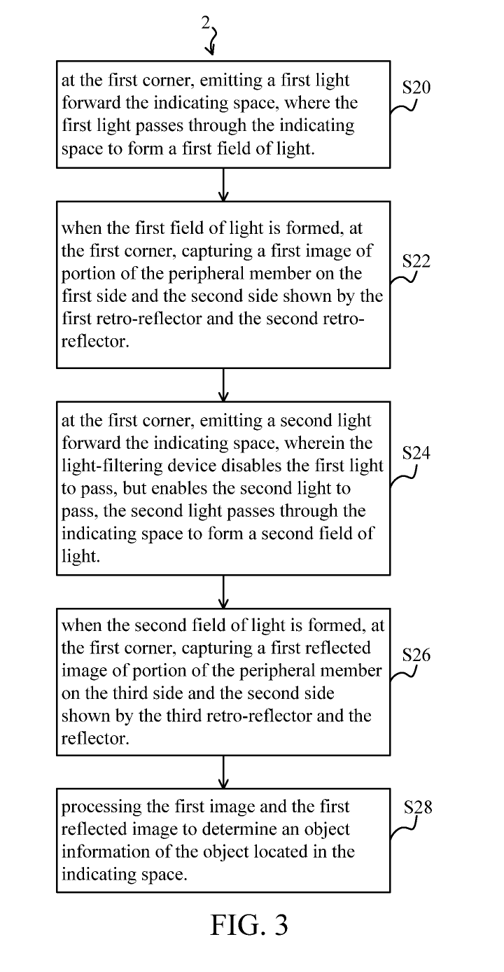

Referring to FIG. 3, FIG. 3 is a flow chart illustrating an object-detecting method 2 according to a preferred embodiment of the invention. The object-detecting method 2 according to the invention is implemented on the basis of a peripheral member, a light-filtering device, a reflector, a first retro-reflector, a second retro-reflector, and a third retro-reflector. The peripheral member defines an indicating space and an indicating plane in the indicating space on which an object directs a target position. The indicating plane defines a first side, a second side adjacent to the first side, a third side adjacent to the second side, and a fourth side adjacent to the third side and the first side. The third side and the fourth side form a first corner. The second side and the third side form a second corner. The light-filtering device is disposed on the peripheral member and located at the first side. The reflector is disposed on the peripheral member and located at the first side and a back of the light-filtering device. The first retro-reflector is disposed on the peripheral member and located at the first side and above or underneath the reflector. The second retro-reflector is disposed on the peripheral member and located at the second side. The third retro-reflector is disposed on the peripheral member and located at the third side.

As to the embodiments of the peripheral member, the light-filtering device, the first retro-reflector, the second retro-reflector, and the third retro-reflector, please refer to those shown in FIGS. 1A and 1B. These embodiments will not be described again.

As shown in FIG. 3, the object-detecting method 2 according to the invention, firstly, performs step S20 to emit, at the first corner, a first light forward the indicating space, where the first light passes through the indicating space to form a first field of light.

Then, the object-detecting method 2 according to the invention performs step S22, to capture, at the first corner, a first image of portion of the peripheral member on the first side and the second side shown by the first retro-reflector and the second retro-reflector when the first field of light is formed.

Next, the object-detecting method 2 according to the invention performs step S24 to emit, at the first corner, a second light forward the indicating space, where the light-filtering device disables the first light to pass, but enables the second light to pass. The second light passes through the indicating space to form a second field of light.

Afterward, the object-detecting method 2 according to the invention performs step S26 to capture, at the first corner, a first reflected image of portion of the peripheral member on the third side and the second side shown by the third retro-reflector and the reflector when the second field of light is formed.

Finally, the object-detecting method 2 according to the invention performs step S28 to process the first image and the first reflected image to determine an object information of the object located in the indicating space. As to contents and determining manners of the object information, they have been described in detail at aforesaid paragraphs, and will be described again.

The object-detecting method 2 according to another embodiment of the invention is also implemented on the basis of a fourth retro-reflector. The fourth retro-reflector is disposed on the peripheral member, and located at the fourth side.

Step S20 is also at the second corner to emit the first light forward the indicating space. Step S22 is also at the second corner to capture a second image of portion of the peripheral member on the first side and the fourth side shown by the first retro-reflector and the fourth retro-reflector. Step S24 is also at the second corner to emit the second light forward the indicating space. Step S26 is also at the second corner to capture a second reflected image of portion of the peripheral member on the third side and the fourth side shown by the third retro-reflector and the reflector. Step S28 is to process at least two among the first image, the second image, the first reflected image, and the second reflected image to determine the object information.

In one embodiment, the firs image and the first reflected image can be captured by use of single line image sensor. The second image and the second reflected image can be captured another line image sensor.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An object-detecting system, comprising:
a peripheral member, the peripheral member defining an indicating space and an indicating plane in the indicating space on which an object directs a target position, the indicating plane defining a first side, a second side adjacent to the first side, a third side adjacent to the second side, and a fourth side adjacent to the third side and the first side, the third side and the fourth side forming a first corner, the second side and the third side forming a second corner;
a light-filtering device, disposed on the peripheral member and located at the first side;
a reflector, disposed on the peripheral member and located at the first side and a back of the light-filtering device;
a first retro-reflector, disposed on the peripheral member and located at the first side and above or underneath the reflector;
a second retro-reflector, disposed on the peripheral member and located at the second side;
a third retro-reflector, disposed on the peripheral member and located at the third side;
a controlling unit;
a first light-emitting unit, electrically connected to the controlling unit and disposed at the periphery of the first corner, the first light-emitting unit comprising a first light source and a second light source, the first light-emitting unit being controlled by the controlling unit to drive the first light source emitting a first light, the first light passing through the indicating space to form a first field of light, the first light-emitting unit being also controlled by the controlling unit to drive the second source emitting a second light, the second light passing through the indicating space to form a second field of light, wherein the light-filtering device disables the first light to pass, but enables the second light to pass; and
a first image-capturing unit, electrically connected to the controlling unit and disposed at the periphery of the first corner, the first image-capturing unit defining a first image-capturing point, the first image-capturing unit being controlled by the controlling unit to capture a first image of portion of the peripheral member on the first side and the second side shown by the first retro-reflector and the second retro-reflector when the first field of light is formed, the first image-capturing unit being also controlled by the controlling unit to capture a first reflected image of portion of the peripheral member on the third side and second side shown by the third retro-reflector and the reflector;
wherein the controlling unit processes the first image and the first reflected image to determine an object information of the object located in the indicating space.

2. The object-detecting system of claim 1, wherein the reflector is a plane mirror.

3. The object-detecting system of claim 1, wherein the reflector comprises a first reflective plane and a second reflective plane, the first reflective plane and the second reflective plane substantially intersect at a right angle of intersection and face the indicating space, the indicating plane defines a primary extension plane, the first reflective plane defines a first secondary extension plane, the second reflective plane defines a second secondary extension plane, the first secondary extension plane and the second secondary extension plane respectively intersect with the primary extension plane at an angle of about 45 degrees.

4. The object-detecting system of claim 1, wherein the first image-capturing unit is a line image sensor.

5. The object-detecting system of claim 1, wherein the object information comprises a relative position of the target position relating to the indicating plane, the controlling unit determines a first object point in accordance with the object in the first image on the first side or the second side, determines a first reflected object point in accordance with the object in the first reflected image on the third side, determines a first straight path in accordance with connectivity between the first image-capturing point and the first object point, determines a first reflective path in accordance with connectivity between the first image-capturing point and the first reflected object point and the reflector, and determines the relative position in accordance with the intersection of the first straight path and the first reflective path.

6. The object-detecting system of claim 1, further comprising:
a fourth retro-reflector, disposed on the peripheral member and located at the fourth side;
a second light-emitting unit, electrically connected to the controlling unit and disposed at the periphery of the second corner, the second light-emitting unit comprising a third light source and a fourth light source, the second light-emitting unit being controlled by the controlling unit to drive the third light source emitting the first light, the second light-emitting unit being also controlled by the controlling unit to drive the fourth light source emitting the second light; and
a second image-capturing unit, electrically connected to the controlling unit and disposed at the periphery of the second corner, the second image-capturing unit defining a second image-capturing point, the second image-capturing unit being controlled by the controlling unit to capture a second image of portion of the peripheral member on the first side and fourth side shown by the first retro-reflector and the fourth retro-reflector when the first field of light is formed, the second image-capturing unit being also controlled by the controlling unit to capture a second reflected image of portion of the peripheral member on the third side and the fourth side shown by the third retro-reflector and the reflector when the second field of light is formed;
wherein the controlling unit processes at least two among the first image, the second image, the first reflected image, and the second reflected image to determine the object information.

7. The object-detecting system of claim 6, wherein the second image-capturing unit is a line image sensor.

8. An object-detecting method, a peripheral member defining an indicating space and an indicating plane in the indicating space on which an object directs a target position, the indicating plane defining a first side, a second side adjacent to the first side, a third side adjacent to the second side, and a fourth side adjacent to the third side and the first side, the third side and the fourth side forming a first corner, the second side and the third side forming a second corner, a light-filtering device being disposed on the peripheral member and located at the first side, a reflector being disposed on the peripheral member and located at the first side and a back of the light-filtering device, a first retro-reflector being disposed on the peripheral member and located at the first side and above or underneath the reflector, a second retro-reflector being disposed on the peripheral member and located at the second side, a third retro-reflector being disposed on the peripheral member and located at the third side, said object-detecting method comprising the steps of:
(a) at the first corner, emitting a first light forward the indicating space, wherein the first light passes through the indicating space to form a first field of light;
(b) when the first field of light is formed, at the first corner, capturing a first image of portion of the peripheral member on the first side and the second side shown by the first retro-reflector and the second retro-reflector;
(c) at the first corner, emitting a second light forward the indicating space, wherein the light-filtering device disables the first light to pass, but enables the second light to pass, the second light passes through the indicating space to form a second field of light;
(d) when the second field of light is formed, at the first corner, capturing a first reflected image of portion of the peripheral member on the third side and the second side shown by the third retro-reflector and the reflector; and
(e) processing the first image and the first reflected image to determine an object information of the object located in the indicating space.

9. The object-detecting method of claim 8, wherein in step (b), a first image-capturing point is defined, in step (e), the object information comprises a relative position of the target position relating to the indicating plane, a first object point is determined in accordance with the object in the first image on the first side or the second side, a first reflected object point is determined in accordance with the object in the first reflected image on the third side, a first straight path is determined in accordance with connectivity between the first image-capturing point and the first object point, a first reflective path is determined in accordance with connectivity between the first image-capturing point and the first reflected object point and the reflector, and the relative position is determined in accordance with the intersection of the first straight path and the first reflective path.

10. The object-detecting method of claim 8, wherein a fourth retro-reflector is disposed on the peripheral member and located at the fourth side, step (a) is also at the second corner to emit the first light forward the indicating space, step (b) is also at the second corner to capture a second image of portion of the peripheral member on the first side and the fourth side shown by the first retro-reflector and the fourth retro-reflector, step (c) is also at the second corner to emit the second light forward the indicating space, step (d) is also at the second corner to capture a second reflected image of portion of the peripheral member on the third side and the fourth side shown by the third retro-reflector and the reflector, step (e) is to process at least two among the first image, the second image, the first reflected image, and the second reflected image to determine the object information.
